(19) United States
(12) Patent Application Publication
(10) Pub. No.: US 2024/0425370 A1
(43) Pub. Date: Dec. 26, 2024

(54) METHOD FOR THE PREPARATION OF SYNTHESIS GAS

(71) Applicant: Topsoe A/S, Kgs. Lyngby (DK)

(72) Inventors: Kim Aasberg-Petersen, Allerød (DK); Pat A. Han, Smørum (DK); Michael Hultqvist, Bagsværd (DK); Peter Mølgaard Mortensen, Roskilde (DK)

(73) Assignee: Topsoe A/S, Kgs. Lyngby (DK)

(21) Appl. No.: 18/818,839

(22) Filed: Aug. 29, 2024

Related U.S. Application Data
(63) Continuation of application No. 16/624,188, filed on Dec. 18, 2019, now abandoned.

(30) Foreign Application Priority Data
Jul. 25, 2017 (DK) PA 2017 00425
Sep. 25, 2017 (DK) PA 2017 00522
May 28, 2018 (DK) PA 2018 00237
Jul. 6, 2018 (DK) PA 2018 00352

(51) Int. Cl. C01B 3/38; C01B 13/02; C25B 1/04; C25B 15/08

(52) U.S. Cl. CPC C01B 3/382; C01B 13/0229; C25B 1/04; C25B 15/08; C01B 2203/0233; C01B 2203/0244; C01B 2203/061; C01B 2203/1241; C01B 2203/142

(57) ABSTRACT

Method for the preparation of synthesis gas combining electrolysis of water, tubular steam reforming and autothermal reforming of a hydrocarbon feed stock.

### CROSS REFERENCE TO RELATED APPLICATIONS

This is a continuation of U.S. patent application Ser. No. 16/624,188, filed Dec. 18, 2019, which is a national stage of PCT/EP2018/069781, filed Jul. 20, 2018, which claims priority to Denmark Application No. PA 2017 00425, filed Jul. 25, 2017, Denmark Application No. PA 2017 00522, filed Sep. 25, 2017, Denmark Application No. PA 2018 00237, filed May 28, 2018, and Denmark Application No. PA 2018 00352, filed Jul. 6, 2018, the entire contents of which are incorporated herein by reference.

### FIELD OF THE INVENTION

The present application is directed to the preparation of synthesis gas. More particular, the invention combines electrolysis of water, tubular steam reforming and autothermal reforming and optionally additionally heat exchange reforming of a hydrocarbon feed stock in the preparation of a hydrogen and carbon oxides containing synthesis gas. Production of synthesis gas e.g. for the methanol synthesis with natural gas feed is typically carried out by steam reforming.

### BACKGROUND

The principal reaction of steam reforming is (given for methane):

CH₄+H₂O⇄3H₂+CO

Similar reactions occur for other hydrocarbons. Steam reforming is normally accompanied by the water gas shift reaction:

CO+H₂O⇄CO₂+H2

Tubular reforming can, for example, be done by, a combination of a tubular reformer (also called steam methane reformer, SMR) and autothermal reforming (ATR), also known as primary and secondary reforming or 2-step reforming. Alternatively, stand-alone SMR or stand-alone ATR can be used to prepare the synthesis gas.

### DETAILED DESCRIPTION

The main elements of an ATR reactor are a burner, a combustion chamber, and a catalyst bed contained within a refractory lined pressure shell. In an ATR reactor, partial oxidation or combustion of a hydrocarbon feed by sub-stoichiometric amounts of oxygen is followed by steam reforming of the partially combusted hydrocarbon feed stream in a fixed bed of steam reforming catalyst. Steam reforming also takes place to some extent in the combustion chamber due to the high temperature. The steam reforming reaction is accompanied by the water gas shift reaction. Typically, the gas is at or close to equilibrium at the outlet of the ATR reactor with respect to steam reforming and water gas shift reactions. The temperature of the exit gas is typically in the range between 850 and 1100° C. More details of ATR and a full description can be found in the art such as “Studies in Surface Science and Catalysis, Vol. 152, “Synthesis gas production for FT synthesis”; Chapter 4, pp. 258-352, 2004.

More details of tubular steam reforming and 2-step reforming can be found in the same reference.

Regardless of whether stand-alone SMR, 2-step reforming, or stand-alone ATR is used, the product gas will comprise hydrogen, carbon monoxide, and carbon dioxide as well as other components normally including methane and steam.

Methanol synthesis gas has preferably a composition corresponding to a so-called module (M=(H2−CO2)/(CO+CO2)) of 1.90-2.20 or more preferably slightly above 2 (eg. 2.00-2.10).

Steam reforming in an SMR typically results in a higher module i.e. excess of hydrogen, while 2-step reforming can provide the desired module. In 2-step reforming the exit temperature of the steam reformer is typically adjusted such that the desired module is obtained at the outlet of the ATR.

In 2-step reforming, the steam methane reformer (SMR) must be large and a significant amount of heat is required to drive the endothermic steam reforming reaction. Hence, it is desirable if the size and duty of the steam reformer can be reduced. Furthermore, the ATR in the 2-step reforming concept requires oxygen. Today, this is typically produced in a cryogenic air separation unit (ASU). The size and cost of this ASU is large. If the oxygen could be produced by other means, this would be desirable.

We have found that when combining tubular steam reforming, autothermal reforming and together with electrolysis of water and/or steam, the expensive ASU can be reduced and even become superfluous in the preparation of synthesis gas.

Thus, this invention provides a method for the preparation of synthesis gas comprising the steps of:
(a) providing a hydrocarbon feed stock;
(b) preparing a separate hydrogen containing stream and a separate oxygen containing stream by electrolysis of water and/or steam;
(c) tubular steam reforming at least a part of the hydrocarbon feed stock from step (a) to a tubular steam reformed gas;
(d) autothermal reforming in an autothermal reformer the tubular steam reformed gas with at least a part of the oxygen containing stream obtained by the electrolysis of water and/or steam in step (b) to an autothermal reformed gas stream comprising hydrogen, carbon monoxide and carbon dioxide;
(e) introducing at least part of the separate hydrogen containing stream from step (b) into the autothermal reformed gas stream from step (d); and
(f) withdrawing the synthesis gas.

In some applications, the oxygen prepared by electrolysis of water introduced into the autothermal reformer in step (d) can additionally be supplemented by oxygen prepared by air separation in an (ASU).

Thus, in an embodiment of the invention, the method according to the invention comprises the further step of separating air into a separate stream containing oxygen and into a separate stream containing nitrogen and introducing at least a part of the separate stream containing oxygen into the autothermal reformer in step (d).

Like the electrolysis of water and/or steam, the air separation can preferably at least be powered by renewable energy.

In all the above embodiments, a part of the hydrocarbon feed stock from step (a) can bypass the tubular steam reforming in step (c) and introduced to the autothermal reformer in step (d)

The module can additionally be adjusted to the desired value by introducing substantially pure carbon dioxide upstream step (c), and/or upstream of step (d) and/or downstream step (d).

The amount of hydrogen added to the reformed gas downstream step (d) can be tailored such that when the hydrogen is mixed with the process gas generated by the reforming steps, the desired value of M of between 1.90 and 2.20 or preferably between 2.00 and 2.10 is achieved.

In one embodiment, the electrolysis unit is operated such that all the hydrogen produced in this unit is added to the reformed gas downstream step (d) and the module of the resulting mixture of this hydrogen and the process gas is between 1.9 and 2.2 or preferably between 2 and 2.1.

In this embodiment some or preferably all the oxygen from the electrolysis unit is added to the autothermal reformer in step (d). Additional oxygen from an air separation unit can be added to the autothermal reformer in this embodiment.

In general, suitable hydrocarbon feed stocks to the tubular reformer and/or the heat exchange reformer(s) for use in the invention comprise natural gas, methane, LNG, naphtha or mixtures thereof either as such or pre-reformed and/or desulfurized.

The hydrocarbon feed stocks may further comprise hydrogen and/or steam as well as other components.

The electrolysis can be performed by various means known in the art such as by solid oxide based electrolysis or electrolysis by alkaline cells or polymer cells (PEM). If the power for the electrolysis is produced (at least in part) by sustainable sources, the CO2-emissions is per unit of product produced by the method reduced.

The method according to the invention is preferably employed for the production 10 methanol by conversion of the synthesis gas withdrawn in step (f)

However, the method according to the invention can also be employed for producing synthesis gas for other applications where it is desirable to increase the hydrogen concentration in the feed gas and where part of the oxygen and hydrogen needed for synthesis gas production is favorably produced by electrolysis.

### EXAMPLE

In the below table a comparison between conventional 2-step reforming and 2-step reforming+electrolysis according to the invention is provided.

COMPARISON TABLE

| | | 2-step |
|---|---|---|
| | 2-step | reforming + |
| | reforming | electrolysis |
| Tubular reformer inlet T | 625 | 625 |
| [° C.] | | |
| Tubular reformer outlet T | 706 | 669 |
| [° C.] | | |
| Tubular reformer inlet P | 31 | 31 |
| [kg/cm² g] | | |
| Tubular reformer min. | 13.38 | 9.48 |
| Required fired duty | | |
| [Gcal/h] | | |
| Tubular reformer outlet | 67180 | 64770 |
| flow [Nm³/h] | | |
| Feed to SMR | | |
| H2 [Nm³/h] | 4099 | 4091 |
| CO2 [Nm³/h] | 897 | 895 |
| CH4 [Nm³/h] | 22032 | 21993 |
| CO [Nm³/h] | 14 | 14 |
| H2O [Nm³/h] | 30313 | 30259 |
| N2 [Nm³/h] | 0 | 0 |
| ATR feed inlet T [° C.] | 708 | 669 |
| ATR oxidant inlet T [° C.] | 240 | 240 |
| ATR outlet T [° C.] | 1050 | 1050 |
| ATR inlet P [kg/cm² g] | 29 | 29 |
| ATR outlet flow [Nm³/h] | 101004 | 100937 |
| Feed to ATR | | |
| H2 [Nm³/h] | 21538 | 17792 |
| CO2 [Nm³/h] | 3598 | 3320 |
| CH4 [Nm³/h] | 17119 | 18235 |
| CO [Nm³/h] | 2226 | 1348 |
| H2O [Nm³/h] | 22698 | 24075 |
| Oxidant to ATR | | |
| H2O [Nm³/h] | 100 | 108 |
| N2 [Nm³/h] | 212 | 228 |
| O2 [Nm³/h] | 10393 | 11148 |
| Electrolysis product | | |
| H2 [Nm³/h]* | 0 | 1493 |
| O2 [Nm³/h]** | 0 | 747 |
| Oxygen from ASU | | |
| O2 [Nm³/h] | 10393 | 10401 |
| Product gas | | |
| H2 [Nm³/h] | 52099 | 52358 |
| CO2 [Nm³/h] | 4679 | 4942 |
| CH4 [Nm³/h] | 364 | 319 |
| CO [Nm³/h] | 17901 | 17642 |
| H2O [Nm³/h]* | 25750 | 26941 |
| N2 [Nm³/h]* | 212 | 2289 |
| Module | 2.10 | 2.10 |

*Included in product gas
**Included in oxidant to ATR

As apparent from the Comparison Table above, the required duty for the tubular reformer can be significantly reduced by the current invention. This duty will in practice translate in to less use of natural gas for heating the SMR. Besides the lower consumption figures of natural gas, this results with an added benefit of less CO₂ emissions in the flue gas stack. Furthermore, the investment of the tubular reformer is substantially reduced.

1. Method for the preparation of synthesis gas, comprising the steps of:
(a) providing a hydrocarbon feed stock;
(b) preparing a separate hydrogen containing stream and a separate oxygen containing stream by electrolysis of water and/or steam;
(c) tubular steam reforming at least a part of the hydrocarbon feed stock from step (a) to a tubular steam reformed gas;
(d) autothermal reforming in an autothermal reformer the tubular steam reformed gas with at least a part of the oxygen containing stream obtained by the electrolysis of water and/or steam in step (b) to an autothermal reformed gas stream comprising hydrogen, carbon monoxide and carbon dioxide;
(e) introducing at least part of the separate hydrogen containing stream from step (b) into the autothermal reformed gas stream from step (d); and
(f) withdrawing the synthesis gas, wherein the electrolysis unit is operated such that all the hydrogen produced in electrolysis unit is added to the reformed gas downstream step
(d) and the module of the resulting mixture of this hydrogen and the process gas is between 1.9 and 2.2, and wherein all the oxygen from the electrolysis unit is added to the autothermal reformer in step (d).

2. The method of claim 1, comprising the further step of separating air into a separate stream containing oxygen and into a separate stream containing nitrogen and introducing at least a part of the separate stream containing oxygen into the autothermal reformer.

3. The method of claim 1, wherein a part of the hydrocarbon feed stock from step (a) is bypassed the tubular steam reforming in step (c) and introduced to the autothermal reformer in step (d).

4. The method of claim 1, wherein the hydrocarbon feed stock comprises natural gas, methane, LNG, naphtha or mixtures thereof either as such or pre-reformed and/or desulfurized.

5. The method of claim 1, wherein the electrolysis of water and/or steam in step (b) is powered at least in part by renewable energy.

6. The method of claim 2, wherein the separating of air is powered at least in part by renewable energy.

7. The method of claim 1, comprising the further step of introducing substantially pure carbon dioxide upstream step (c), and/or upstream of step (d), and/or downstream step (d).

8. The method of claim 1, wherein the module M=(H₂−CO₂)/(CO+CO₂) in the synthesis gas withdrawn in step (f) is in the range from 2 to 2.1.

9. The method of claim 1, wherein the synthesis gas withdrawn in step (f) is in a further step converted to a methanol product.
